(19) United States
(12) Patent Application Publication
(10) Pub. No.: US 2022/0288688 A1
(43) Pub. Date: Sep. 15, 2022

(54) CLADDED TOOL AND METHOD OF MAKING A CLADDED TOOL

(71) Applicant: MILWAUKEE ELECTRIC TOOL CORPORATION, Brookfield, WI (US)

(72) Inventors: Jonathan G. Winter, Burlington, WI (US); Jason M. Thom, Wauwatosa, WI (US); Carl Dietz, Menomonee Falls, WI (US); Zachary J. Geschke, Milwaukee, WI (US); Milorad Marich, Mequon, WI (US)

(21) Appl. No.: 17/636,109

(22) PCT Filed: Oct. 22, 2020
(86) PCT No.: PCT/US2020/056743

§ 371 Date: Feb. 17, 2022

Related U.S. Application Data
(60) Provisional application No. 62/924,486, filed on Oct. 22, 2019.

(51) Int. Cl. B22F 10/25; B22F 7/08; B22F 10/34

(52) U.S. Cl. CPC B22F 10/25; B22F 7/08; B22F 10/34; B22F 2005/001

(57) ABSTRACT

A method of creating a cladded tool with a distributor including a feed mechanism and an energy source. The method includes providing a substrate and distributing particulate material from the feed mechanism onto the substrate. The particulate material includes agglomerated particles with diameters between 30 and 100 microns. The method also includes activating the energy source to produce a beam spot on the particulate material, the substrate, or both and at least partially melting the particulate material, the substrate, or both with the beam spot to form a bonded layer of particulate material on the substrate.

### CROSS REFERENCE TO RELATED APPLICATIONS

This application claims priority to U.S. Provisional Patent Application Ser. No. 62/924,486, filed on Oct. 22, 2019, the entire contents of which are incorporated by reference herein.

### BACKGROUND OF THE INVENTION

The present invention relates to cladding, and in particular, laser cladding a portion of a tool.

Cladding involves the bonding of dissimilar metals. Laser cladding is a process for adding one material to the surface of another material in a controlled manner. Typically, a stream of desired powdered material is fed into a laser beam that is focused on an article to be cladded. As the laser scans the surface, the powder material is bonded to the material of the article.

### SUMMARY

The invention provides, in one independent aspect, a method of creating a cladded tool with a distributor including a feed mechanism and an energy source. The method includes providing a substrate and distributing particulate material from the feed mechanism onto the substrate. The particulate material includes agglomerated particles with diameters between 30 and 100 microns. The method also includes activating the energy source to produce a beam spot on the particulate material, the substrate, or both and at least partially melting the particulate material, the substrate, or both with the beam spot to form a bonded layer of particulate material on the substrate.

The invention provides, in another independent aspect, a cladded tool including a substrate and a cladded layer bonded to the substrate to form a working edge of the cladded tool. The cladded layer includes agglomerated particles having diameters between 30 and 100 microns.

The invention provides, in another independent aspect, a method of creating a cladded tool with a distributor including a feed mechanism and an energy source. The method includes providing a substrate and distributing particulate material from the feed mechanism onto the substrate. The particulate material includes hard phase particles. The method also includes activating the energy source to produce a beam spot on the particulate material, the substrate, or both and at least partially melting the particulate material, the substrate, or both with the beam spot to form a bonded layer of the particulate material on the substrate. The bonded layer has a higher concentration of hard phase particles further from the substrate than adjacent the substrate.

The invention provides, in another independent aspect, a cladded tool including a substrate and a cladded layer bonded to the substrate to form a working edge of the cladded tool. The cladded layer is formed of particulate material including hard phase particles. The cladded layer has a higher concentration of hard phase particles further from the substrate than adjacent the substrate.

The invention provides, in another independent aspect, a cladded saw blade including a body and a cladded cutting edge bonded to the body. The cladded cutting edge including a plurality of cutting teeth.

Other aspects of the invention will become apparent by consideration of the detailed description and accompanying drawings.

### BRIEF DESCRIPTION OF THE DRAWINGS

FIG. 1 is schematic view of a laser cladding system.

FIG. 2 is a perspective view of the laser cladding system of FIG. 1.

FIG. 3 is a perspective view of a saw blade including a laser cladded cutting edge.

FIG. 4A is an elevational view of an oscillating multi tool blade including a laser cladded cutting edge.

FIG. 4B is an enlarged view of a cutting edge of the oscillating multi tool blade of

FIG. 4A.

FIGS. 5A-5I illustrate a variety of different types of tools capable of having laser cladded portions.

FIG. 6 is enlarged view of macro-particles for using in a cladding process.

FIG. 7 is an enlarged, plan view of a laser cladded tooth of a cutting edge of an oscillating multi tool blade.

FIG. 8 is an enlarged, plan view of a laser cladded tooth of a cutting edge of another oscillating multi tool blade.

FIG. 9 is a flowchart of a method of creating a laser cladded tool.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

With reference to the drawings, the invention provides a cladded tool and a method of making a cladded tool. The method is particularly suited to laser cladding the outside surface of metallic objects such as, for example, cutting, impacting, drilling, and grinding tools. For example, reciprocating saw blades, oscillating multi-tool (OMT) blades, auger drill bits, circular saw blades, hole saw blades, step drill bits, pilot bits, hammer bits, hand tools, knife blades, razor blades, etc. may all be laser cladded to improve the efficacy of the operation the tool is being used for. Such tools may be used, for example, with power tools such as drills and other saws. The method may be also particularly suited to laser clad tools with relatively small cutting edges. For example, the method is suited to laser clad the cutting edge of OMT blades with a high teeth per inch (TPI). Laser cladding, however, is not limited to the above-mentioned applications and other applications of laser cladding are possible.

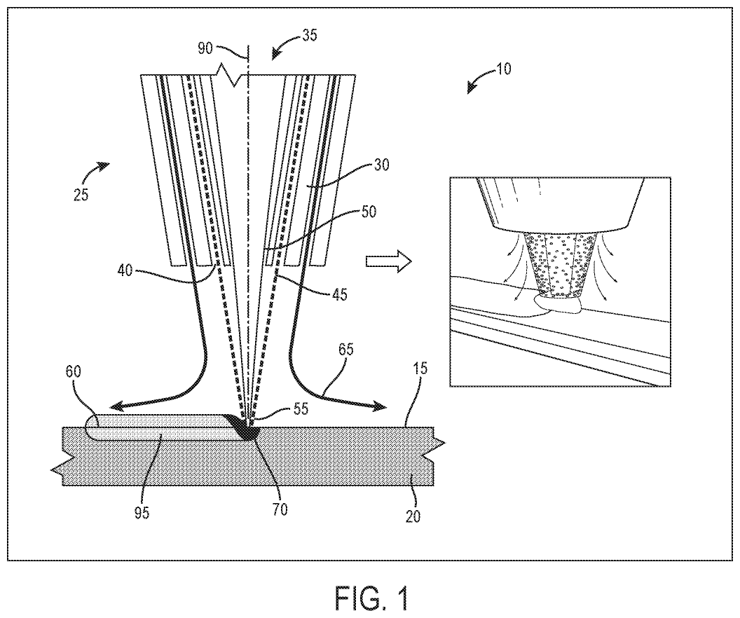

FIG. 1 illustrates a system 10 for laser cladding an outer surface 15 of an article 20, such as a tool. The system includes a distributor 25 having a feed mechanism 30 and an energy source 35. The feed mechanism 30 includes a feed nozzle 40 to supply a granular or powder material 45. The feed mechanism 30 may be coupled to piping or supply lines that connect the feed nozzle 40 to a reservoir or container that stores the powder material 45. The feed mechanism 30 is configured to supply the powder material 45 to the outer surface 15 of the article 20. In some embodiments, the distributor 25 may distribute more than one type of powder material 45. As such, the feed mechanism 30 may include additional storage tanks to store additional types of powder materials 45.

The energy source 35 is provided to apply heat to the powder material 45 and a target portion on the surface 15 of the article 20. In the illustrated embodiment, the energy source 35 includes a laser. When powered, the energy source 35 produces a laser beam 50 that includes a beam spot 55 positioned on the target area of the surface 15 of the article 20. The energy source 35 also includes a control mechanism (not shown) to selectively control the laser beam 50 to produce a desired output power. Additionally, the control mechanism may change the size of the beam spot 55 or the geometry of the beam spot 55.

Preferably, the energy source 35 produces a desired power output to heat the powder material 45 and the target area of the surface 15 of the article 20. The heat will at least partially melt both the powder material 45 and the surface 15 of the article 20 so that when the laser beam 50 passes the target area, the molten powder material 45 and the surface 15 of the article 20 fuse (or otherwise cooperate or interact) to form a bonded coating layer 60 on the surface 15 of the article 20. In the illustrated embodiment, the distributor 25 includes both the feed mechanism 30 and the energy source 35. In other embodiments, the feed mechanism 30 and the energy source 35 may be separate components so that the powder material 45 is distributed from a separate component from which the laser beam 50 is produced.

During a cladding operation, the distributor 25 is configured to produce a protective layer of shield gas 65 to protect the laser beam 50 and the feed nozzle 40. The shield gas 65 may also contain the powder material 45 within an interaction zone (i.e., melt pool 70) to increase the yield of the distributed powder material 45.

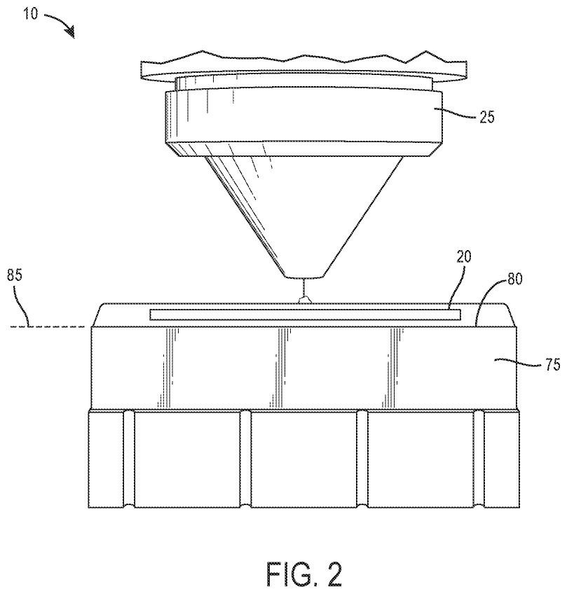

In the illustrated embodiment, the article 20 is arranged to be movable relative to the distributor 25. Specifically, the distributor 25 remains fixed during a cladding operation while the article 20 is mounted on a workstation 75 (FIG. 2) that is movable. The workstation 75 is movable within a plane 85 defined by a surface 80 of the workstation 75. The workstation 75 is capable of moving in linear or non-linear paths or patterns within the plane 85 (e.g., the Cartesian coordinates axes (i.e., x-, y-, z-axes)) to laser clad articles of varying shapes and sizes. In some embodiments, the distributor 25 is movable relative to the workstation 75 and the article 20 to provide a desired position, orientation, and spacing between the respective components.

The workstation 75, the feed mechanism 30, and the energy source 35 may all be controlled by a single control system that receives input from a user to move in a designated pattern that corresponds to a specific geometry of the article 20. For instance, the system 10 may be controlled by a computer numerically controlled (CNC) unit. The CNC unit is adapted to move the workstation 75 at a desired speed, while the feed mechanism 30 and energy source 35 simultaneously track along the plane 85. In addition, the CNC unit may be configured to control the feed rate of the feed nozzle 40 and the power output of the energy source 35.

The powder material 45 may be selected to have predetermined chemical and physical properties that facilitate coalescing, fusing, mixing, feeding, and/or bonding with the material of the article 20. In some embodiments, the powder material 45 is a powdered metallic material that is advantageously adapted to form a strong metallurgical bonded wear resistant coating layer on the surface 15 of the article 20 following a laser cladding operation. In the illustrated embodiment, the powder material 45 is a metal matrix composite (MMC) having characteristics adapted to provide high abrasive and erosive wear resistance properties in the coating layer 60. The MMC includes a matrix material and a hard phase particle dispersed within the matrix material. The MMC may comprise between approximately 5 to 90 percent by weight of the matrix material (i.e., binder phase) and from 10 to 90 percent by weight of the hard phase particle (i.e., carbide phase). In other embodiments, the MMC may comprise between 10 to 50 percent by weight of the matrix material and 50 to 90 percent by weight of the reinforcing material.

The matrix material is in the form of a powder self-fluxing alloy. For example, the matrix material may be selected from the group, including but not limited to, nickel, cobalt, iron, boron, silicon, or any combination thereof. The matrix material may have a particle size (e.g., diameter) less than 200 μm. In some embodiments, the matrix material may have a particle size between 1 μm and 200 μm. In other embodiments, the matrix material may have a submicron particle size between 0.5 μm and 1 μm. The particle size of the matrix material may be relatively uniform or may be variable.

Nickel, cobalt or iron based self-fluxing alloys are preferred for the matrix material, due to their lower melting temperatures and associated lower reactive influence on the carbide particles. In addition, nickel, cobalt, and iron have excellent wetting characteristics with the carbide particles and the base metal.

The carbide hard phase particle is also a particulate material and preferably selected from the group including, but not limited to, tungsten carbide, titanium carbide, chromium carbide, niobium carbide, silicon carbide, vanadium carbide, diamond, a cubic boron nitride, tool steel, and boron carbide. Preferably, the hard phase particle includes a high hardness, a high melting point, and resists chemical attack from the molten MMC. Additionally, the reinforcing layer may exhibit good wettability with molten metals. The hard phase particle may have a particle size (e.g., diameter) of less than 350 μm. In other embodiments, the hard phase particle may have a particle size less than 200 μm. In some embodiments, the hard phase particle may have a particle size between 1 μm and 350 μm. In other embodiments, the hard phase particle may have a particle size between 5 μm and 200 μm. The particle size of the hard phase particle may be relatively uniform or may be variable.

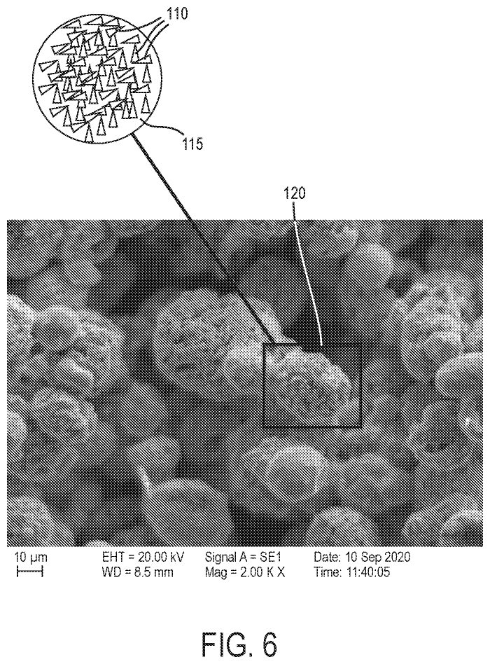

In the illustrated embodiment, the matrix material and the hard phase particle are combined and agglomerated into a larger macro-particle. For example, as shown in FIG. 6, hard phase particles 110, such as tungsten carbide, that are 0.8 μm to 1.0 μm may be agglomerated with a matrix material 115, such as cobalt, to form an agglomerated macro-particle 120 that is 30 μm to 100 μm. Since the hard phase particle 110 is typically sharp and angular, the increase in particle size increases the flowability of the hard phase particle 110. The agglomerated macro-particles 120 may be consistently distributed from the feed nozzle 40. As such, the agglomerated macro-particle 120 may have a flowability of 8-14 seconds based on the ASTM B213 standard.

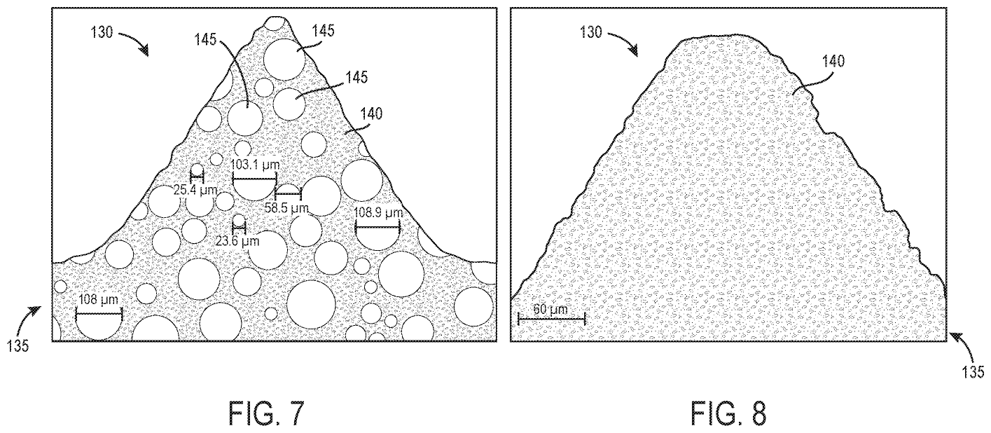

FIG. 7 illustrates a tool 130 including a laser cladded cutting edge 135 with cutting teeth 140. During the laser cladding operation, the size of the hard phase particles 110 is between 50 μm to 100 μm and the hard phase particles 110 are individually distributed onto the article 20. However, using the large hard phase particles 110 produces large areas 145 in the laser cladding cutting edge 135 that do not include the hard phase particle 115. In contrast, FIG. 8 illustrates the laser cladded cutting edge 135 when the hard phase particles 110 are agglomerated with the matrix material 120. As shown, there is a greater area covered with the hard phase particles 110 which results in increased wear resistance of the teeth 140.

In some embodiments, the agglomerated macro-particle 120 can be made of between 10% and 20% cobalt and between 80% and 90% tungsten carbide. In other embodiments, the agglomerated macro-particle 120 can be made up of 12% cobalt and 88% tungsten carbide. In other embodiments, the agglomerated macro particle 120 can be made up of other combinations of cobalt and tungsten carbide. In some embodiments, the agglomerated macro-particle 120 can be combined with additional matrix materials (i.e. cobalt, nickel, etc.) to assist with hard phase retention and distribution. In some embodiments, the agglomerated macro-particle 120 is the only powder being fed, deposited, and melted.

In some embodiments, the hard phase particles and the matrix material particles are blended together to form a composition with desired percentages before being delivered to the feed nozzle 40 of the feed mechanism 30. In some embodiments, the materials may need to be blended before adding the composition to a storage tank that is in communication with the feed mechanism 30. As mentioned above, in other embodiments, the hard phase particles and the matrix material particles can be fed separately through the feed nozzle 40 via separate pipes.

During a cladding operation, the energy source 35 and the feed mechanism 30 cooperate to provide a substantially continuous, steady, and even flow of powder material to the melt pool 70, as seen in FIG. 1. The CNC unit, or independent control and/or sensing means, is provided to continuously monitor and, if necessary, adjust the input parameters to either or both of the energy source 35 and the feed mechanism 30 such that the desired continuous, steady, even flow of powder material 45 is achieved and maintained over the cladding operation. Additionally, the CNC unit, or independent control and/or sensing means may start and stop the energy source 35 and the feed mechanism separately or simultaneously. For example, the CNC unit may stop the flow of powder from the feed mechanism 30 in order to do additional laser recoating layers. Further advantages of depositing wear coating layers 60 include reduction of total laser heat input, smaller mean carbide particle sizes, higher percentage of entrained carbide, and dissolution of the carbide, lower dilution with base material, and smaller heat affected zones. A further advantage is the elimination of surface porosity by adding multiple laser recoating passes without adding more powder to ensure full melting of the powder on the substrate. In some embodiments, a homogenous powder, like a Fe-based tool steel powder like M2 can be deposited. The hardness is achieved from a phase transformation during the melting and solidification of the powder, as opposed to the MMC, where the hard phase is mixed in with a matrix material.

In the illustrated embodiment, the powder material 45 includes between 5% and 90% by weight matrix material and between 5% and 90% by weight hard phase particle. It has been observed in trials that an MMC having these exemplary properties, when used in combination with predetermined laser cladding parameters, produces coating layers 60 having improved properties and characteristics in terms of wear performance. Further factors may affect the MMC layer, such as the powder material morphology and the particle size distribution within the MMC.

As illustrated in FIG. 1, the feed nozzle 40 extends around the energy source 35. In other words, the feed nozzle 40 is concentric with the laser beam 50 produced by the energy source 35. The feed nozzle 40 is operable to supply powder material 45 at an angle relative to the surface 15 of the article 20 (e.g., the feed nozzle 40 feeds the powder material 45 along an axis 90, that is concentric with the laser beam 50, within the range of 0 to 90 degrees relative to the surface 15 of the article 20). The feed nozzle 40 is configured to feed the powder material 45 to the beam spot 55 of the laser beam 50 so that powder material 45 passes through the laser beam 50 adjacent the melt pool 70. In other embodiments, the feed nozzle 40 may deposit the powder material 45 in a location behind or ahead of the beam spot 55 of the laser beam 50.

The distributor 25 is also operable to control the mass flow of the powder material 45 from the reservoir holding the powder material 45. For instance, the distributor 25 may control the feed rate of the powder material 45 that is deposited from the feed nozzle 40. In the illustrated embodiment, the distributor 25 is operable to produce a powder feed rate up to 30 grams per minute. In other embodiments, the distributor 25 is operable to produce a powder feed rate greater than 30 grams per minute. In addition, the distributor 25 is operable to control the gas flow rate of the shield gas 65. For example, the distributor may be operable to dispense up to 50 liters per minute. The shield gas 65 can preferably be selected from a group consisting of, but not limited to, argon, neon, xenon, radon, nitrogen, or krypton. The distributor 25 may be capable of outputting the shield gas 65 at various gas flow rates. Additionally, the gas flow rate may be adjusted based on the beam spot size, desired layer thickness, and layer morphology. Further, the distributor 25 may be controlled by the CNC unit to mix up the powder material 45 or to preheat the powder material 45 prior to being deposited from the feed nozzle 40. For example, the distributor 25 may include a stirrer to mix the powder material 45 prior to exiting the feed nozzle 40.

The distributor 25 may also be operable to adjust the distance the laser beam 50 travels from the energy source 35 to contact the surface 15 of the article 20. As such, the distributor 25 may be moveable relative to the workstation 75 and the article 20. For example, the distributor 25 may move in a direction orthogonal to the surface 15 of the article 20 to increase or decrease the length of the laser beam 50 that extends from the laser. Preferably, during a laser cladding operation, the laser beam 50 extends from the distributor 25 a distance between a ¼ inch and 3 feet. In other embodiments, the distance may be more than 3 feet or less than a ¼ inch. Additionally, the distributor 25 may be pivotable to adjust the energy source 35 and the feed nozzle 40 at different angles relative to the surface 15 of the article 20. For instance, the distributor 25 may be pivoted to an angle between 0 and 90 degrees relative to the surface 15 of the article 20. As such, the energy source 35 may be orientated at an angle to produce a laser beam 50 that is angled relative to the surface 15 of the article 20, and the feed mechanism 30 may be oriented at an angle to deposit powder material 45 at an angle relative to the surface 15 of the article 20. In some embodiments, the energy source 35 and the feed mechanism 30 may be orientated at separate angles from each other relative to the surface 15 of the article 20.

The article 20 may include a substrate material that is the base of the article 20. The substrate is typically a metal such as tool steel, titanium or aluminum. In some embodiments, the substrate material may be selected from ultra-high-strength steel (D6A), alloy steel (6150), carbon steel (1075), or low carbon steel (1020). In other embodiments, the substrate material may be other types of steels. The substrate may be pretreated before a cladding operation. For example, the substrate may be annealed or quenched and tempered before a cladding operation to remove internal stresses and increase the mechanical properties of the substrate material. In addition, the thickness of the substrate may affect the dilution of the powder material 45 during a cladding operation. As such, the thickness of the substrate material may vary. For instance, the substrate may have a thickness that is greater than 0.02 mm. Alternatively, the substrate may have a thickness that is less than 30 mm. In some embodiments, the substrate may have a thickness between 0.02 mm and 30 mm. The surface of the substrate may also include a surface finish. The surface finish may be to provide a smooth clean surface for the cladding operation.

Before a cladding operation, the substrate material may be pre-heated to accelerate the fusion between the article 20 and the powder material 45. In addition, pre-heating the substrate can help reduce the cooling rates, which will decrease the effects of the varying coefficient of thermal expansion (CTE) for the substrate and deposited MMC. The pre-heat can also be used to control cooling rates which influences the hardness and phase transformations associated with the laser deposition process. To pre-heat the substrate material, the article 20 may be placed in a heating source, such as an oven, furnace, or an induction coil. The pre-heating process may be affected by many variables, such as, the ramp rate, the temperature, the time, and the time between the pre-heat and the cladding operation. For example, the substrate material may be subjected to variable heat during the pre-heating process. As such, the rate at which the temperature rises may vary until a maximum temperature is reached. The ramp rate may be between 10 and 100 degrees Fahrenheit per second. Additionally, the substrate may be preheated to a maximum temperature of 350 degrees F., 500 degrees F., 750 degrees F., 900 degrees F., or 1050 degrees F. for a predetermined amount of time. In some embodiments, the maximum temperature may be between 350 degrees F. and 1050 degrees F. In further embodiments, when the substrate is steel, the maximum temperature is not to exceed the Al temperature associated with phase transformation to austenite. Alternatively, the maximum temperature may be greater than 350 degrees F. The predetermined amount of time may be between 1 and 30 minutes. Further, the substrate may be let to rest/cool for up to an hour before beginning the cladding operation. Although, in some embodiments, minimal rest/cool time may be preferred. As such, the rest/cool time may be between 10 seconds and 5 minutes.

In the illustrated embodiment, the article 20 may be formed to a specific shape and size either prior to the cladding operation or after the cladding operation. For example, the teeth of a saw blade may be formed prior to the cladding operation or after the cladding operation. In the case where the teeth are formed prior to the cladding operation, a machining tool may cut or grind an edge of the article 20 to form teeth or a cutting edge. Then, during a cladding operation, coating layers 60 are applied in a pattern to match the cutting edge/teeth of the article 20. Alternatively, coating layers 60 may first be applied to a straight edge of the article 20. Once a predetermined number of coating layers 60 are applied, the article 20 may then be cut or ground in a specific pattern to produce teeth or a cutting edge. In other embodiments, the coating layers 60 may be formed into the final desired shape (or near final desired shape) of the article. In such embodiments, no (or only minimal) cutting or grinding may be needed to produce teeth or a cutting edge. In addition, cutting edges of drill bits may be formed prior to or after a cladding operation as described above.

As mentioned, the energy source 35 is operable to emit the laser beam 50 through an optical focusing mechanism in a direction substantially orthogonal to the surface 15 of the article 20. In some embodiments, the focusing mechanism may be in the form of a series of lenses that focus and direct the beam towards the target area of the surface 15 of the article 20. The location that the laser beam 50 contacts the surface 15 of the article 20 is the beam spot 55. The CNC unit is operable to control the energy source 35 to produce a beam spot 55 with a varying size and geometry. For example, the laser beam 50 may have a beam spot 55 with a diameter or width of at least 0.5 mm. Alternatively, the laser beam 50 may have a beam spot 55 with a diameter or width that is less than 20 mm. In other embodiments, the laser beam 50 may have a beam spot 55 with a diameter or width between 0.5 mm and 20 mm. Additionally, the CNC unit is operable to control the geometry of the beam spot 55. For instance, the beam spot 55 may be circular, triangular, oval-shaped, square, rectangular, or ellipse-shaped.

As mentioned above, the energy source 35 is controlled by a CNC unit that is capable of selectively adjusting and controlling the power output of the energy source 35. The energy source 35 is preferably selected from the group, including but not limited to, CO2 lasers, Nd:YAG lasers, Nd:YVO4 lasers, diode pumped with Nd:YAG lasers, diode lasers, disc lasers, infrared lasers, and fiber lasers. The energy source 35 preferably has a power output of at least 1 kW. Alternatively, the energy source 35 may have a power output less than 20 kW. In some embodiments, the energy source 35 may have a power output within the range of approximately 1 kW to 20 kW. For example, the energy output for a fiber laser may be between 300 watts to 1.8 kW. Additionally, or alternatively, the power output of the energy source 35 may be varied during a cladding operation. It will of course be appreciated by those skilled in the art that the invention is not limited to applications with the energy source 35 operating within the specified power range, but rather may be selected so as to have the necessary power requirements for the intended cladding application.

During a cladding operation, the energy source 35 melts the surface 15 of the article 20 to a predetermined depth, thereby forming the melt pool 70 on the surface 15 of the article 20. The powder material 45 is simultaneously melted. The predetermined chemical and physical properties of the powder material 45 are selected such that the molten powder material 45 and substrate metal in the melt pool 70 coalesce to form a metallurgically bonded wear resistant coating layer 60 on the surface 15 of the article 20.

In the illustrated embodiment, the energy source 35 is controllable to adjust the depth that the laser beam 50 penetrates the surface 15 of the article 20 to melt the substrate. The portion of the substrate that melts is the dilution area 95. The ability to control the depth to which the surface 15 of the article 20 melts reduces the dilution area 95 of the substrate metal within the molten melt pool 70, thereby substantially maintaining the initial and intended material properties of the powder material 45 upon formation of the wear resistant coating layers 60. The material properties of the powder material 45 may include, for example, its composition and hardness. In this context, geometric dilution is defined as the ratio of the cladding depth in the substrate to the total clad height. It is possible to achieve dilution rates of less than 5% with the laser cladding process described herein, subject to suitably accurate control of the laser parameters within a narrow processing range.

As is described in further detail below, the use of a lower specific heat energy (i.e., output power of the energy source 35) arises through the use of relatively higher travel or scan speeds. In particular, faster scanning speeds, which advantageously enables the size of the melt pool 70 to be reduced, may necessitate the requirement of multiple passes (reduced pitch/increased overlap) to achieve the desired thickness. Faster scanning speeds may also lower the conductive losses in the base material, thereby enabling the lower power required for a given material feed rate. Consequently, and advantageously, this enables the use of an increased material feed rate and heat source scanning speed for the same output power of the energy source 35. Additionally, sometimes it may be advantageous to do one pass at a slower scanning speed than multiple passes at a faster scanning speed.

The energy source 35 is configured such that a coating layer 60 is deposited or applied to the surface 15 at a predetermined travel speed, being the speed at which the energy source 35 (and thus melt pool 70) travels with respect to the surface 15 of the article 20 (i.e., the speed of movement of the laser beam 50 along or over the surface 15 of the article 20). For example, with a laser power output in the range of 1 kW to 10 kW, travel speeds may typically be set to within the range of 500 mm/min to 2,000 mm/min. In other embodiments, the travel speeds may vary. However, it has been found that improved cladding properties (including improved wear resistance) can be achieved by increasing the travel speed of the energy source 35. In some embodiments, setting the travel speed within the range of 4,000 mm/min to 40,000 mm/min provides particular advantages in terms of improvements to cladding properties (including improved wear resistance) of the coating layers 60. The higher travel speeds of the energy source 35 described herein are beneficial in producing a coating layer 60 with substantially greater even distribution of powder material 45 within the coating layer 60, substantially lower dilution with the substrate and smaller heat effected zones.

As mentioned above, as the distributor 25 scans over the article 20, a coating layer 60 is produced on the article 20. In the illustrated embodiment, multiple coating layers 60 are deposited on the article 20. For example, an article 20 may comprise between 1 and 50 coating layers 60. In some embodiments, each coating layer 60 may be between 0.1 mm and 10 mm thick. Each coating layer 60 may be melt bonded to the next during a scan of the distributor 25. As such, each scan and each coating layer 60 may overlap with the previously applied coating layer 60. A coating layer 60 may be overlapped with the previously applied coating layer 60 to an extent within the range of approximately 0% to 60% of the width of the coating layer 60, with the desired thickness/height of the coating layer 60 achieved with each scan. In some embodiments, a coating layer 60 may be overlapped with a previous coating layer 60 more than 50% the width of the coating layer 60.

After a cladding operation, the article 20 may be subjected to additional heat treatments. For example, the article 20 may be heat tempered or hardened. During tempering and hardening, the temperature of a heat source and the amount of time the article 20 is exposed to the heat may be varied. During hardening, the furnace atmosphere and the quenchant or liquid applying the quenching may be varied.

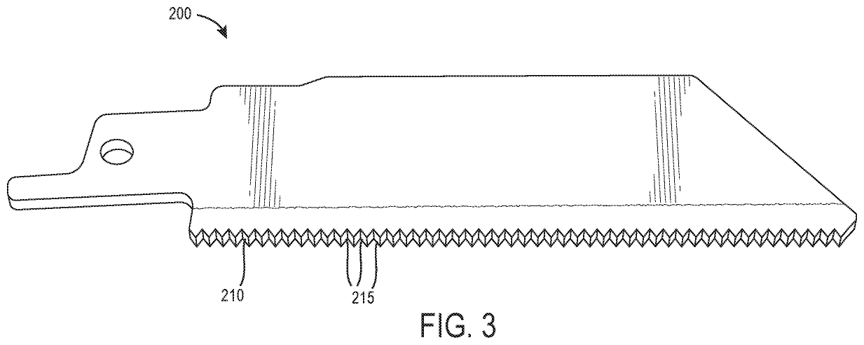

FIG. 3 illustrates the article 20 as a reciprocating saw blade 200 for use with a reciprocating saw. The reciprocating saw blade 200 includes a backing or body made from an ultra-high-strength steel that has been annealed. The reciprocating saw blade 200 also includes laser cladded cutting edge 210 to improve its wear resistance. In the illustrated embodiment, the cutting edge 210 has a pitch of 20 TPI along its length. The cutting edge 210 is formed of multiple coating layers 60 produced by laser cladding. For example, the illustrated cutting edge 210 includes fourteen coating layers 60. The coating layers 60 create a buildup of approximately 3.3 mm at the cutting edge 210. In other embodiments, the cutting edge 210 may be formed of fewer or more coating layers, and/or the coating layers 60 may create a smaller or larger buildup. A plurality of cutting teeth 215 are defined in the coating layers 60

Prior to a cladding operation, the reciprocating saw blade 200 is pre-heated. For example, the reciprocating saw may be pre-heated at an induction ramp rate to a desired temperature over a predetermined amount of time. In some embodiments, the desired temperature may be at least 350 degrees F. In other embodiments, the desired temperature may be between 350 degrees F. and 600 degrees F. In some embodiments, the predetermined amount of time may be less than one minute. In other embodiments, the predetermined amount of time may be between 10 second and 30 seconds.

During the cladding operation, the distributor 25 deposits the powder material at a predetermined rate. In some embodiments, the predetermined rate may be 30 grams/min or less. In other embodiments, the predetermined rate may be more than 30 grams/min. In further embodiments, the predetermined rate may be between 2 grams/min and 30 grams/min. The distributor 25 also controls the shield gas a predetermined rate. In some embodiments, the predetermined rate may be at least 5 L/min. In other embodiments, the predetermined rate may be less than 500 L/min. In further embodiments, the predetermined rate may be between 5 L/min and 50 L/min.

The energy source 35 may generate a beam spot and operate at a desired power. In some embodiments, the beam spot may have a size (e.g., width or diameter) of at least 0.5 mm. In other embodiments, the beam spot may have a size less than 20 mm. In further embodiments, the beam spot may have a size between 0.5 mm and 20 mm. In some embodiments, the desired power may be at least 300 W. In other embodiments, the desired power may be less than 750 W. In further embodiments, the desired power may be between 300 W and 750 W. In further embodiments, the desired power may be more than 750 W

The CNC unit may move the saw blade 200 at a desired travel or scan speed relative to the energy source 35. In some embodiments, the desired travel speed is at least 500 mm/min. In other embodiments, the desired travel speed is less than 2000 mm/min. In further embodiments, the desired travel speed is between 500 and 2000 mm/min. In further embodiments, the desired travel speed may be more than 2000mm/min.

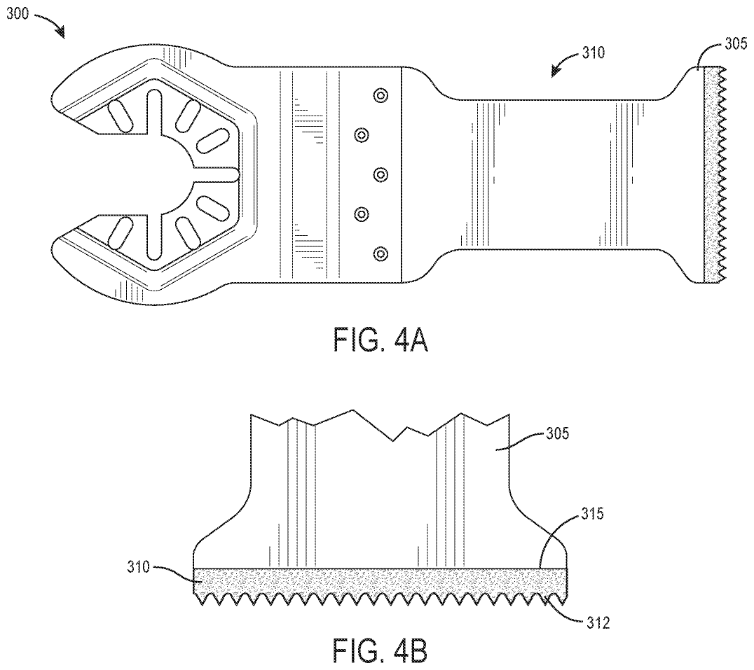

With reference to FIG. 4A, the article is an oscillating multi-tool blade 300 with a body 305 and a cutting edge 310. The cutting edge 310 of the OMT blade 300 has been laser cladded with multiple coating layers 60 to improve its wear resistance. The laser cladding of the cutting edge 310 and the body are separated by an interface 315. A plurality of cutting teeth 320 are defined within the coating layers 60 of the cutting edge 310. As can be seen, the OMT blade 300 includes a much greater tooth per inch ratio (TPI) than the reciprocating saw blade 200 described above. For example, the OMT blade 200 may include a pitch up to 50 TPI. In some embodiments, the OMT blade may include a pitch that is more than 50 TPI. In other embodiments, the cutting edge 310 may include a pitch that is greater than 25 TPI.

With reference to FIG. 4B, during the laser cladding process, as the coating layers 60 are built up, the substrate of the OMT blade nearer the interface 315 includes a lower percentage of hard phase particles than on the cutting teeth 312 of the cutting edge 310. In other words, as the coating layers 60 are built up, more of the hard phase particles are laser cladded near the cutting teeth 312 than the interface 315 between the substrate and the laser cladding. For example, the area percentage of hard phase particles near the cutting teeth 312 may be in a range between 45% and 80%. Alternatively, the area percentage of hard phase particles near the interface 315 may be in a range between 20% and 40% percent. In other embodiment, the area percentage of hard phase particles near the cutting teeth 312 may be greater than 80% or less than 45%. Further, the area percentage of hard phase particles near the interface 315 may be greater than 40% or less than 20%.

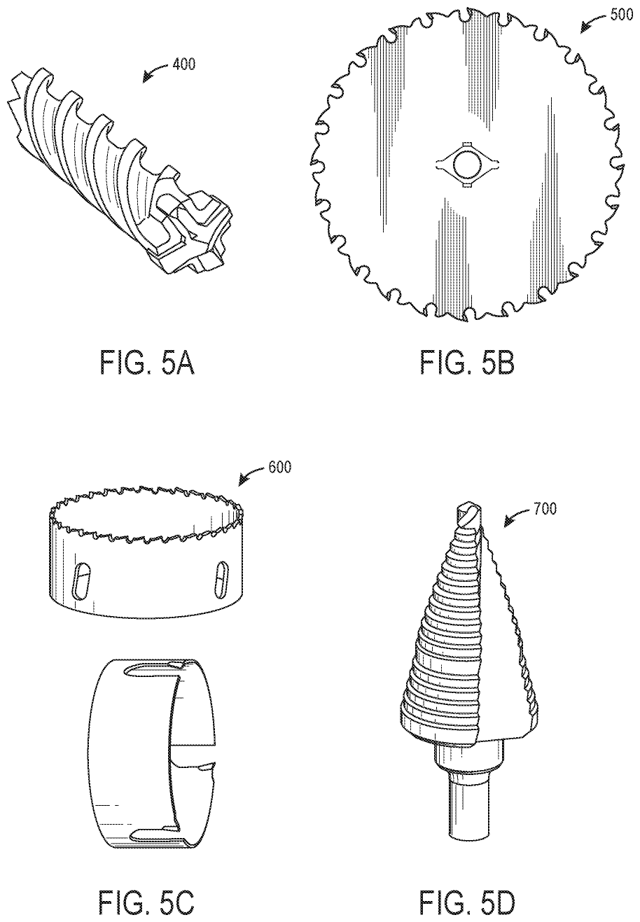

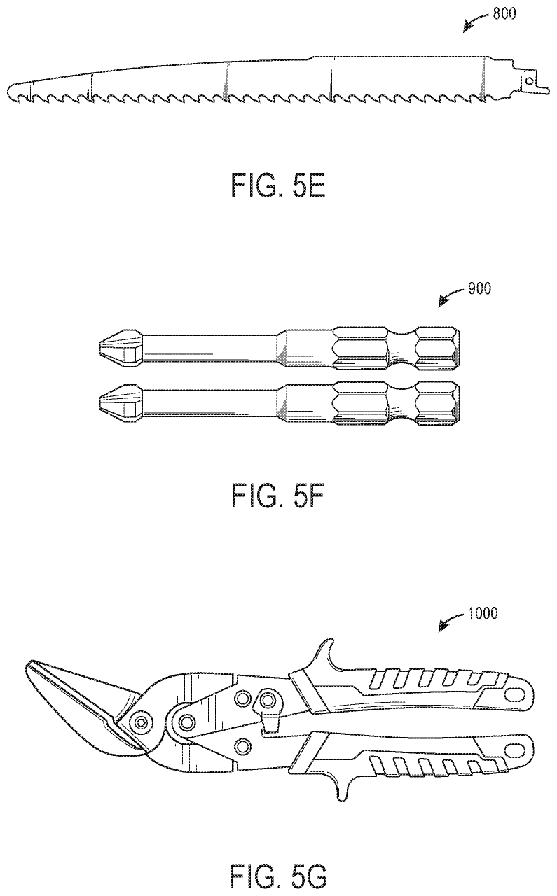

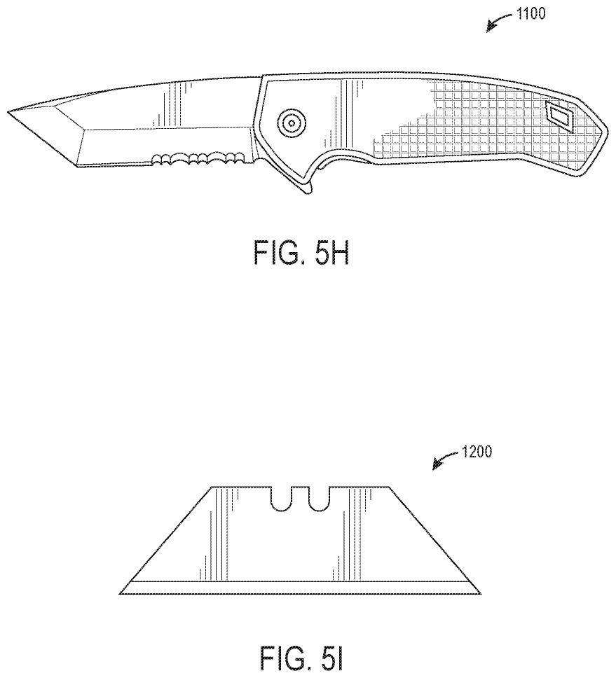

FIGS. 5A-5I illustrate other laser cladded articles. For example, the above described laser cladding process may be used on auger bits 400 (FIG. 5A), circular saw blades 500 (FIG. 5B), hole saw blades 600 (FIG. 5C), step drill bits 700 (FIG. 5D), reciprocating saw blades 800 (FIG. 5E), hammer drill bits 900 (FIG. 5F), hand tools 1000 (FIG. 5G), pocket knives 1100 (FIG. 5H), or razor blades 1200 (FIG. 5I).

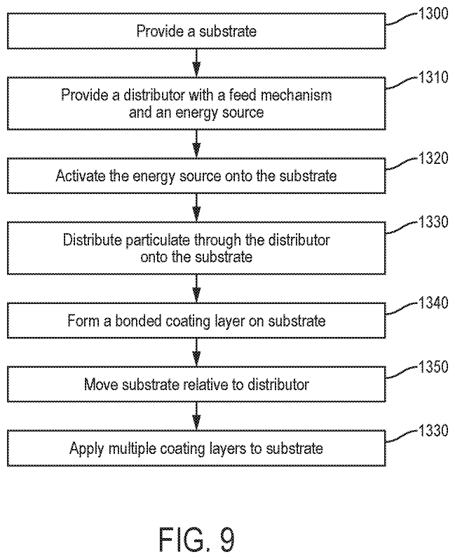

FIG. 9 illustrates a flowchart for a laser cladding method. Although the flowchart includes particular steps, not all of the steps need to be performed or need to be performed in the order presented. The first step 1300 in the method is to provide a substrate. The second step 1310 in the method is to provide a distributor including a feed mechanism and an energy source. The third step 1320 is to activate the energy source onto the substrate. In some embodiments, activating the energy source includes activating a laser beam to produce a beam spot on the substrate. The fourth step 1330 is to distribute a particulate through the distributor onto the substrate. Specifically, distribute the particulate onto the substrate at the position of the beam spot to produce a melt pool. In some embodiments, the particulate is an agglomerated particulate. The fifth step 1340 is to form a bonded coating layer on a surface of the substrate. In some embodiments, the bonded coating layer is formed with a higher percentage of hard phase particles adjacent an outside boundary of the bonded coating layer than an inside boundary relative to the substrate. The sixth step 1350 is to move the substrate relative to the distributor to extend the coating layer on the surface of the substrate. The seventh step 1360 is to apply multiple coating layers to the substrate by repeating the previous six steps.

Although the invention has been described in detail with reference to certain embodiments above, variations and modifications exist within the scope and spirit of the invention.

Various features and advantages of the invention are set forth in the following claims.

What is claimed is:

1. A method of creating a cladded tool with a distributor including a feed mechanism and an energy source, the method comprising:
providing a substrate;
distributing particulate material from the feed mechanism onto the substrate, the particulate material including agglomerated particles having diameters between 30 and 100 microns;
activating the energy source to produce a beam spot on the particulate material, the substrate, or both; and
at least partially melting the particulate material, the substrate, or both with the beam spot to form a bonded layer of particulate material on the substrate.

2. The method of claim 1, wherein each agglomerated particle includes a matrix material and a hard phase particle.

3. The method of claim 2, wherein the particulate material includes a second matrix material that is separate from the matrix material of the agglomerated particles.

4. The method of claim 2, wherein the matrix material is cobalt and the hard phase particle is tungsten carbide.

5. The method of claim 4, wherein the agglomerated particle is 12% cobalt and 88% tungsten carbide.

6. The method of claim 1, further comprising moving one of the substrate or the distributor relative to the other of the substrate or the distributor to form the bonded layer along a length of the substrate.

7. The method of claim 6, wherein moving one of the substrate or the distributor relative to the other of the substrate or the distributor includes moving the one of the substrate or the distributor relative to the other of the substrate or the distributor to from multiple bonded layers of particulate material on the substrate.

8. The method of claim 1, further comprising forming a cutting edge on the substrate with the bonded layer of particulate material.

9. The method of claim 8, wherein forming the cutting edge includes forming a plurality of cutting teeth on the substrate with the bonded layer of particulate material.

10. A cladded tool comprising:
a substrate; and
a cladded layer bonded to the substrate to form a working edge of the cladded tool, the cladded layer including agglomerated particles having diameters between 30 and 100 microns.

11. The cladded tool of claim 10, wherein each agglomerated particle includes a matrix material and a hard phase particle.

12. The cladded tool of claim 11, wherein the cladded layer includes a higher area concentration of hard phase particles further from the substrate than adjacent the substrate.

13. The cladded tool of claim 11, wherein the matrix material is cobalt and the hard phase particle is tungsten carbide.

14. The cladded tool of claim 10, further comprising a plurality of cladded layers bonded to the substrate to form the working edge of the cladded tool, each cladded layer including agglomerated particles having diameters between 30 and 100 microns.

15. The cladded tool of claim 10, wherein the cladded tool is a saw blade, and wherein the working edge includes a plurality of cutting teeth.

16. The cladded tool of claim 10, wherein the cladded tool is one selected from a group consisting of a drill bit, a hand tool, a knife, and a razor blade, and wherein the working edge is a cutting edge.

17. A method of creating a cladded tool with a distributor including a feed mechanism and an energy source, the method comprising:
providing a substrate;
distributing particulate material from the feed mechanism onto the substrate, the particulate material including hard phase particles;
activating the energy source to produce a beam spot on the particulate material, the substrate, or both; and
at least partially melting the particulate material, the substrate, or both with the beam spot to form a bonded layer of the particulate material on the substrate, the bonded layer having a higher concentration of hard phase particles further from the substrate than adjacent the substrate.

18. The method of claim 17, wherein the hard phase particles are tungsten carbide.

19. The method of claim 17, wherein an area percentage of hard phase particles further from the substrate is between 45 percent and 80 percent, and wherein the area percentage of hard phase particles adjacent the substrate is between 20 percent and 40 percent.

20. The method of claim 17, further comprising moving one of the substrate or the distributor relative to the other of the substrate or the distributor to form the bonded layer along a length of the substrate.

21. The method of claim 20, wherein moving one of the substrate or the distributor relative to the other of the substrate or the distributor includes moving the one of the substrate or the distributor relative to the other of the substrate or the distributor to form multiple bonded layers of particulate material on the substrate.

22. A cladded tool comprising:
a substrate; and
a cladded layer bonded to the substrate to form a working edge of the cladded tool, the cladded layer formed of particulate material including hard phase particles, the cladded layer having a higher concentration of hard phase particles further from the substrate than adjacent the substrate.

23. The cladded tool of claim 22, wherein the hard phase particles are tungsten carbide.

24. The cladded tool of claim 22, wherein an area percentage of hard phase particles further from the substrate is between 45 percent and 80 percent, and wherein the area percentage of hard phase particles adjacent the substrate is between 20 percent and 40 percent.

25. The cladded tool of claim 22, wherein the cladded tool is a saw blade, and wherein the working edge includes a plurality of cutting teeth.

26. The cladded tool of claim 22, wherein the cladded tool is one selected from a group consisting of a drill bit, a hand tool, a knife, and a razor blade, and wherein the working edge is a cutting edge.

27. A cladded saw blade comprising:
a body;
a cladded cutting edge bonded to the body, the cladded cutting edge including a plurality of cutting teeth.

28. The cladded saw blade of claim 27, wherein the plurality of cutting teeth has a pitch between 20 teeth per inch and 50 teeth per inch.

29. The cladded saw blade of claim 27, wherein the cladded cutting edge includes agglomerated particles having diameters between 30 and 100 microns.

30. The cladded saw blade of claim 27, wherein the cladded cutting edge a higher area percentage of hard phase particles further from the body than adjacent the body.
